(19) United States
(12) Patent Application Publication
(10) Pub. No.: US 2019/0036094 A1
(43) Pub. Date: Jan. 31, 2019

(54) SECONDARY BATTERY

(71) Applicant: DAICEL CORPORATION, Osaka-shi, Osaka (JP)

(72) Inventors: Yo YAMATO, Himeji-shi (JP); Masao IWAYA, Tokyo (JP)

(73) Assignee: DAICEL CORPORATION, Osaka-shi, Osaka (JP)

(21) Appl. No.: 16/072,801

(22) PCT Filed: Nov. 30, 2016
(86) PCT No.: PCT/JP2016/086286

§ 371 Date: Jul. 25, 2018

(30) Foreign Application Priority Data
Jan. 25, 2016 (JP) 2016-011853
Jan. 25, 2016 (JP) 2016-011854

(51) Int. Cl. H01M 2/16; H01M 10/0569; H01M 10/0525; H01M 4/66

(52) U.S. Cl. CPC H01M 2/16; H01M 4/66; H01M 10/0525; H01M 10/0569

(57) ABSTRACT

The present invention provides a secondary battery including a separator which is better in heat resistance than conventional polyolefin-based separators for secondary batteries so that safety can be improved, and which has a low electric resistance while maintaining insulation. It is also an object of the present invention to provide a secondary battery that is excellent in wettability for electrolytic solution, and excellent in productivity in an assembling step of the secondary battery.

The secondary battery of the present invention is a secondary battery comprising: a negative electrode; a positive electrode; a separator disposed between the electrodes; and an electrolytic solution, wherein the separator is a porous film, or a porous film laminate having a porous film integrated with a support, a main component of the porous film is a polyetherimide-based resin, and in the configuration of the secondary battery described in this specification, an ion resistance value of the separator as determined by a measuring method described in this specification is 0.18 Ω or less. The secondary battery of the present invention is also a secondary battery comprising: a negative electrode; a positive electrode; a separator disposed between the electrodes; and an electrolytic solution, wherein the separator is a porous film, or a porous film laminate having a porous film integrated with a support, a main component of the porous film is a polyetherimide-based resin, and the separator has an electrolytic solution penetration rate value of 10 to 30 mm/30 minutes in an MD direction.

### TECHNICAL FIELD

The present invention relates to a secondary battery comprising a negative electrode, a positive electrode, a separator disposed between the electrodes, and an electrolytic solution. This application claims priority of Japanese Patent Application No. 2016-011853 and No. 2016-011854 filed on Jan. 25, 2016 in Japan, which are incorporated herein by reference in their entirety.

### BACKGROUND ART

Secondary batteries (nonaqueous), such as lithium ion batteries, have already extensively spread mainly for use in portable devices, such as cellular phones, and they are indispensable nowadays. The secondary batteries are also used as on-board batteries for vehicles such as hybrid vehicles, plug-in hybrid vehicles, and electric vehicles and also as industrial batteries, and further expansion of the application of the secondary batteries is expected. The on-board and industrial batteries are required to have higher capacity, higher output, larger size, and high safety. In this connection, a separator is required to be excellent in ionic permeability for enabling lithium ions to uniformly pass therethrough with low resistance and is required to have safety, such as heat resistance and short-circuit resistance. Since the separator influences the productivity in an assembling step of the secondary batteries, the separator is also required to be good in wettability for an electrolytic solution.

As the separator for secondary batteries, a polyolefin-based separator has generally and conventionally been used as disclosed in Patent Literature 1. However, a problem of the polyolefin-based separator is that because the polyolefin-based separator is mainly manufactured by forming tear pores by stretching, the formed tear pores become monotonous through-holes and a short-circuit may be caused by lithium dendrites or the like generated by charging and discharging. Another problem is that in order to avoid the occurrence of the short-circuit, the polyolefin-based separator is required to have very microscopic pores and a low void content, and as a result it becomes difficult for lithium ions or the like to pass, and the electric resistance becomes large.

The polyolefin-based separator has a shutdown function in which when the temperature rises due to a certain cause, the fine pores open in the separator clog at about 130° C. to shut down electric current or ions. However, when the temperature rises fast, the fine pores clog as well as the separator shrinks, which may cause a short-circuit of the electrodes, and the separator is melted down, which may cause the separator to lose its very function.

Yet another problem is that the polyolefin-based separator is inherently poor in wettability or retentivity for a nonaqueous electrolytic solution used in lithium-ion secondary batteries or for a gel electrolytic solution used in lithium polymer secondary batteries, and in addition, all the more because of the microscopic pores and low void content is poor in wettability and retentivity for the electrolytic solution.

The electrolytic solution formed by dissolving an electrolyte, such as LiPF₆, LiBF₄, and LiClO₄, in an organic polar solvent, such as ethylene carbonate, propylene carbonate, and γ-butyrolactone, is mainly used. When the wettability and retentivity of the separator toward the electrolytic solution are poor, the productivity in an assembling step of the batteries deteriorates, and the battery performance, such as charging and discharging characteristics and cycle characteristics of the secondary batteries are adversely affected. Therefore, it is strongly desired to improve the wettability of the separator.

In order to cope with such a problem, a polyolefin-based separator having a heat-resistant protective layer (HRL) provided on one side or both sides of the separator is disclosed. Examples of the separator provided with the heat-resistant protective layer (HRL) may include Patent Literature 2 (HRL; heat-resistant resin porous layer) and Patent Literature 3 (HRL; heat-resistant inorganic porous layer).

However, although these heat-resistant protective layers (HRL) have a limited effect that is an effect to improve the heat resistance to some extent, the separator basically uses a polyolefin-based resin as a substrate, so that shrink and meltdown cannot completely be prevented, and therefore the essential problem is yet to be solved. Since the polyolefin-based separator is consistently used as a substrate, and the separator is manufactured by forming tear pores by stretching, the formed tear pores are still monotonous through-holes so that the separator has very microscopic pores and a low void content, and as a result it is difficult for lithium ions or the like to pass, and thereby the problem of a large electric resistance, and the problem of poor wettability of the polyolefin-based separator still remain as they are. Rather, the electric resistance tends to be larger, which is worse, since the separator is formed by coating one side or both the sides of the substrate with the heat-resistant protective layer (HRL).

Although Patent Literature 4 discloses that the wettability is improved by dispersing polyamide of a size of 5 μm or less in polyolefin as a main component, it is extremely difficult to completely compatibilize polyolefin and polyamide, and the effect of improving the wettability of the polyolefin as a main component is limited. There is also a possibility that polyamide dissolves into the electrolytic solution, which may cause gradual change in composition of the electrolytic solution and reduction in battery performance.

Patent Literature 5 discloses a polyetherimide-based porous film, which is stated to be utilized in filters, electrolyte membrane supports, circuit substrates, and printing substrates. It is also disclosed that the porous film can be utilized as a fuel cell separator and a fuel cell electrolyte membrane (support) by filling up the pores with a functional material, but application of the porous film to the separator for secondary batteries is not disclosed.

Since the fuel cell separator is originally a plate-shaped component for partitioning each cell and pores are not opened in the fuel cell separator, porous materials are not usable. Consequently, it is considered that the fuel cell separator disclosed in Patent Literature 5 refers to the same component as the fuel cell electrolyte membrane (support). As widely known, the fuel cell is not a kind of battery but a kind of power generator with the structure completely different from that of what is called the battery.

The electrolyte membrane support, which is not an essential component of the fuel cells, is used in the fuel cells with its pores completely filled up with a solid electrolyte. Meanwhile, since the separator in secondary batteries is adapted to prevent a short-circuit of the electrodes, and is used with the pores not being filled up so that lithium ions or the like need to freely pass through the pores, the separator is also completely different in usage from that in the fuel cells.

### CITATION LIST

### Patent Literature

### Patent Literature 1

Japanese Patent Laid-Open No. 2001-081221 Patent Literature 2

Japanese Patent Laid-Open No. 2005-209570 Patent Literature 3

International Publication No. 2008/062727 Patent Literature 4

Japanese Patent Laid-Open No. 2002-226639 Patent Literature 5

Japanese Patent Laid-Open No. 2007-126638

### SUMMARY OF INVENTION

### Technical Problem

As a separator for secondary batteries, the polyolefin-based separator has been mainly used as described above, and the electric resistance large to some extent attributed to the manufacturing method and the structure of the separator was left without being improved. However, for higher output and effective energy use of the secondary batteries, the separator is required to have excellent ionic permeability for allowing lithium ions or the like to uniformly pass therethrough with a low resistance. At the same time, the separator for secondary batteries is also required to have higher heat resistance in view of past firing accidents and to enhance safety in vehicle use and industrial use.

Therefore, it is an object of the present invention to provide a secondary battery including a separator which is better in heat resistance than conventional polyolefin-based separators for secondary batteries so that safety can be improved, and which has a low electric resistance while maintaining insulation. It is also an object of the present invention to provide a secondary battery that is excellent in wettability for electrolytic solution and excellent in productivity in an assembling step of the secondary battery.

### Solution to Problem

As a result of keen examination to accomplish the above objects, the inventors of the present invention have found out that the above problems could be solved in the secondary battery which uses a porous film having a polyetherimide-based resin as a main component, as a separator, and have completed the present invention.

That is, a secondary battery of the present invention is a secondary battery comprising: a negative electrode; a positive electrode; a separator disposed between the electrodes; and an electrolytic solution, wherein the separator is a porous film or a porous film laminate having a porous film integrated with a support, a main component of the porous film is a polyetherimide-based resin, and in the following configuration of the secondary battery, an ion resistance value of the separator as determined by the following measuring method is 0.18Ω or less:

Configuration of the secondary battery: the positive electrode and the negative electrode defined below are made to face each other through the separator, and inserted into an aluminum laminate outer packaging, an electrolytic solution (1M-LiPF₆/3EC7MEC) is injected into the outer packaging, and after impregnation under reduced pressure, the outer packaging is vacuum-sealed;

Positive electrode: a laminate formed by laminating a mixture of a ternary system positive-electrode active material (NCM):AB:PVdf=93:4:3 on an aluminum foil current collector, the laminate being 30 mm in width, 50 mm in length, and 80 μm in thickness;

Negative electrode: a laminate formed by laminating a mixture of graphite:CMC:SBR=97.5:1:1.5 on a copper foil current collector, the laminate being 32 mm in width, 52 mm in length, and 70 μm in thickness; and

Measuring method: measuring an alternating-current impedance of the secondary battery with an impedance analyzer under conditions of a scanning frequency of 0.1 Hz to 50000 Hz and a voltage amplitude of 10 mV, obtaining an X intercept of an obtained Nyquist plot as a direct-current resistance component of the secondary battery, and subtracting blank resistance from the X intercept to obtain an ion resistance value of the separator.

A secondary battery of the present invention is a secondary battery comprising: a negative electrode; a positive electrode; a separator disposed between the electrodes; and an electrolytic solution, wherein the separator is a porous film or a porous film laminate having a porous film integrated with a support, a main component of the porous film is a polyetherimide-based resin, and the separator has an electrolytic solution penetration rate value of 10 to 30 mm/30 minutes in an MD direction.

In the secondary battery of the present invention, the separator preferably has an electrolytic solution penetration rate value of 12 to 30 mm/30 minutes in a TD direction.

In the secondary battery of the present invention, the porous film of the separator preferably has a large number of micro-pores having communicating properties, the micro-pores having an average pore size of 0.01 to 10 μm, the porous film preferably has an average aperture ratio of 30 to 80%, the separator preferably has an air permeability value of 0.5 to 100 seconds, and the separator preferably has a thickness of 10 to 60 μm.

In the secondary battery of the present invention, the micro-pores of the porous film preferably have an average pore size of 0.05 to 5 μm.

In the secondary battery of the present invention, the porous film preferably has an average aperture ratio of 40 to 80%.

In the secondary battery of the present invention, the separator preferably has an air permeability value of 0.5 to 50 seconds.

In the secondary battery of the present invention, the separator preferably has a thickness of 15 to 50 μm.

In the secondary battery of the present invention, the current collector of the negative electrode is preferably copper foil or stainless steel.

In the secondary battery of the present invention, the current collector of the positive electrode is preferably aluminum foil or stainless steel.

In the secondary battery of the present invention, a polymer solution including 8 to 25% by weight of a polyetherimide-based resin component, 5 to 50% by weight of a water-soluble polymer, 0 to 10% by weight of water, and 30 to 82% by weight of a water-soluble polar solvent is preferably used as a raw material of the porous film.

In the secondary battery of the present invention, a content of the water-soluble polymer is preferably 5 to 40 parts by weight per 100 parts by weight in total of the polyetherimide-based resin component and the water-soluble polar solvent.

That is, the present invention relates to the following:

(1) A secondary battery comprising: a negative electrode; a positive electrode; a separator disposed between the electrodes; and an electrolytic solution, wherein the separator is a porous film or a porous film laminate having a porous film integrated with a support, a main component of the porous film is a polyetherimide-based resin, and in the configuration of the secondary battery, an ion resistance value of the separator as determined by the measuring method is 0.18Ω or less.
(2) A secondary battery comprising: a negative electrode; a positive electrode; a separator disposed between the electrodes; and an electrolytic solution, wherein the separator is a porous film or a porous film laminate having a porous film integrated with a support, a main component of the porous film is a polyetherimide-based resin, and the separator has an electrolytic solution penetration rate value of 10 to 30 mm/30 minutes in an MD direction.
(3) The secondary battery according to (2) wherein the separator has an electrolytic solution penetration rate value of 12 to 30 mm/30 minutes in a TD direction.
(4) The secondary battery according to any one of (1) to (3) wherein the porous film of the separator has a large number of micro-pores having communicating properties, the micro-pores having an average pore size of 0.01 to 10 μm, the porous film has an average aperture ratio of 30 to 80%, the separator has an air permeability value of 0.5 to 100 seconds, and the separator has a thickness of 10 to 60 μm.
(5) The secondary battery according to any one of (1) to (4), wherein the micro-pores of the porous film have an average pore size of 0.05 to 5 μm.
(6) The secondary battery according to any one of (1) to (5), wherein the porous film has an average aperture ratio of 40 to 80%.
(7) The secondary battery according to any one of (1) to (6), wherein the separator has an air permeability value of 0.5 to 50 seconds.
(8) The secondary battery according to any one of (1) to (7), wherein the separator has a thickness of 15 to 50 μm.
(9) The secondary battery according to any one of (1) to (8) wherein the separator has a tensile strength of 2.0 N/15 mm or more.
(10) The secondary battery according to any one of (1) to (9) wherein the content of polyetherimide-based resin is 50% by weight or more based on the total amount of components constituting the porous film.
(11) The secondary battery according to any one of (1) to (10) wherein an aperture ratio (surface aperture ratio) on the surface of the porous film is 48% or more.
(12) The secondary battery according to any one of (1) to (11) wherein a surface roughness (arithmetic average surface roughness Sa) of the porous film is 0.5 μm or less.
(13) The secondary battery according to any one of (1) to (12), wherein the current collector of the negative electrode is copper foil or stainless steel.
(14) The secondary battery according to any one of (1) to (13), wherein the current collector of the positive electrode is aluminum foil or stainless steel.
(15) The secondary battery according to any one of (1) to (14), wherein the porous film is a porous film manufactured by a method of obtaining the porous film comprising: flow-casting a polymer solution containing a polyetherimide-based resin into the form of a film on a film base; applying a pore making treatment to the film by contacting the film with a coagulation liquid; then separating the film from the film base; and then drying the film.
(16) The secondary battery according to any one of (1) to (15), wherein a raw material of the porous film is a polymer solution comprising 8 to 25% by weight of a polyetherimide-based resin component, 5 to 50% by weight of a water-soluble polymer, 0 to 10% by weight of water, and 30 to 82% by weight of a water-soluble polar solvent.
(17) The secondary battery according to (16), wherein the content of the water-soluble polymer is 5 to 40 parts by weight per 100 parts by weight in total of the polyetherimide-based resin component and the water-soluble polar solvent.

### Advantageous Effects of Invention

The secondary battery of the present invention is better in heat resistance than conventional polyolefin-based separators for secondary batteries so that safety can be improved, and is low in electric resistance. The secondary battery of the present invention is good in heat resistance and retentivity of the separator so that safety can be improved, excellent in wettability of the separator for the electrolytic solution, and good in productivity in the assembling step of the secondary battery.

### BRIEF DESCRIPTION OF DRAWINGS

FIG. 1 is a conceptual block diagram illustrating one example of a secondary battery of the present invention.

FIG. 2 is an electron microscope photograph (SEM photograph) of the surface of a porous film fabricated in Manufacturing Example 1.

FIG. 3 illustrates observation photographs of an electrolytic solution development status (after 5 minutes) in Comparative Example 2 and Example 2.

### DESCRIPTION OF EMBODIMENTS

### Secondary Battery

A secondary battery of the present invention is a secondary battery comprising: a negative electrode; a positive electrode; a separator disposed between the electrodes; and an electrolytic solution, wherein the separator is a porous film or a porous film laminate having a porous film integrated with a support, a main component of the porous film is a polyetherimide-based resin, and in the following configuration of the secondary battery, an ion resistance value of the separator as determined by the following measuring method is 0.18Ω or less:

Configuration of the secondary battery: the positive electrode and the negative electrode defined below are made to face each other through the separator, inserted into an aluminum laminate outer packaging, an electrolytic solution (1M-LiPF₆/3EC7MEC) is injected into the outer packaging, and after impregnation under reduced pressure, the outer packaging is vacuum-sealed;

Positive electrode: a laminate formed by laminating a mixture of a ternary system positive-electrode active material (NCM):AB:PVdf=93:4:3 on an aluminum foil current collector, the laminate being 30 mm in width, 50 mm in length, and 80 μm in thickness;

Negative electrode: a laminate formed by laminating a mixture of graphite:CMC:SBR=97.5:1:1.5 on a copper foil current collector, the laminate being 32 mm in width, 52 mm in length, and 70 μm in thickness; and

Measuring method: measuring an alternating-current impedance of the secondary battery with an impedance analyzer under conditions of a scanning frequency of 0.1 Hz to 50000 Hz and a voltage amplitude of 10 mV, obtaining an X intercept of an obtained Nyquist plot as a direct-current resistance component of the secondary battery, and subtracting blank resistance from the X intercept to obtain an ion resistance value of the separator.

The electrolytic solution (1M-LiPF₆/3EC7MEC) represents an electrolytic solution in which 1 mol of lithium hexafluorophosphate (LiPF₆) as an electrolyte is present in 1 L of a solvent containing ethylene carbonate (EC) and methylethyl carbonate (MEC) at a mixture ratio (weight) of 3:7. The ternary system positive-electrode active material (NCM) in the material of the positive electrode is a substance consisting of the three kinds nickel, cobalt, and manganese, AB is acetylene black, and PVdf is polyvinylidene fluoride. CMC in the material of the negative electrode is carboxymethylcellulose, and SBR is styrene-butadiene rubber.

A secondary battery of the present invention is a secondary battery comprising: a negative electrode; a positive electrode; a separator disposed between the electrodes; and an electrolytic solution, wherein the separator is a porous film or a porous film laminate having a porous film integrated with a support, a main component of the porous film is a polyetherimide-based resin, and the separator has an electrolytic solution penetration rate value of 10 to 30 mm/30 minutes in an MD direction. The separator preferably has an electrolytic solution penetration rate value of 12 to 30 mm/30 minutes in a TD direction.

In the present invention, the secondary battery, which is not particularly limited in shape, has a general shape, such as a circular shape (cylindrical shape, coin shape, button shape), or a rectangle shape. The secondary battery, which is not particularly limited also in structure, has a general structure formed by winding a battery element, which comprises a negative electrode, a positive electrode, and a separator disposed between these electrodes, into a cylindrical shape or a flat shape, or has a laminated structure, the battery element being structured to be enclosed in an outer packaging. The outer packaging can be applied to any forms, such as a metal casing, and an aluminum laminate film case. In the present invention, the secondary battery may properly comprise as components constituting the secondary battery, in addition to the negative electrode, the positive electrode, the separator, the electrolytic solution, and the outer packaging, members generally used in a secondary battery, such as an electric insulating plate, a gasket, a gas exhaust valve, a positive electrode tab, and a negative electrode tab. The secondary battery of the present invention may be any secondary battery, such as a lithium ion battery, a lead-acid battery, a nickel-hydrogen battery, and a nickel-cadmium battery.

### Negative Electrode

As the negative electrode, a general negative electrode formed by, for example, applying on a current collector a layer molded from a negative electrode active material, a binder, and a conductive assistant may be used. The negative electrode can be fabricated by adding a solvent to the negative electrode active material, the binder, and the conductive assistant, kneading the produced mixture to fabricate a slurry, applying the slurry on the current collector, and drying and pressing the current collector. When the total weight of the negative electrode active material, the binder, and the conductive assistant is 100%, the weights of the negative electrode active material, the binder, and the conductive assistant are preferably in the range of 80 to 98% by weight, 2 to 20% by weight, and 0 to 10% by weight, respectively. As the negative electrode active material, materials capable of doping and dedoping lithium are used, such as carbon-based materials, silicon-based materials, and tin-based materials. Examples of the carbon material may include materials, such as meso-carbon microbeads and micro carbon fibers, having a precursor that is easily graphitized such as pitch, and materials, such as a phenol resin, having a precursor that is hardly graphitized. Examples of the binder may include polyvinylidene fluoride and carboxymethylcellulose. Examples of the conductive assistant preferably include graphite powder, acetylene black (AB), Ketjen black, and vapor growth carbon fiber. Examples of the current collector of the negative electrode preferably include copper foil and stainless steel.

### Positive Electrode

As the positive electrode, like the negative electrode, a general positive electrode formed by, for example, applying on a current collector a layer formed from a positive electrode active material, a binder, and a conductive assistant may be used. The positive electrode can be fabricated by adding a solvent to the positive electrode active material, the binder, and the conductive assistant, kneading the produced mixture to fabricate a slurry, applying the slurry on the current collector, and drying and pressing the current collector. When the total weight of the positive electrode active material, the binder, and the conductive assistant is 100%, the weights of the positive electrode active material, the binder, and the conductive assistant are preferably in the range of 80 to 98% by weight, 2 to 20% by weight, and 0 to 10% by weight, respectively. As the positive electrode active material, lithium-containing transition metal oxides may be used, including LiCoO₂, LiNiO₂, spinel-type LiMn₂O₄, olivine-type LiFePO₄, and solid solutions formed by solid-solving different elements to these metal oxides, and a mixture of these may be used. Examples of the binder preferably include polyvinylidene fluoride. Examples of the conductive assistant preferably include graphite powder, acetylene black (AB), Ketjen black, and vapor growth carbon fiber. Examples of the current collector of the positive electrode preferably include aluminum foil and stainless steel.

### Electrolytic Solution

As the electrolytic solution, a nonaqueous electrolytic solution formed by dissolving lithium salt in a nonaqueous solvent is used. Examples of the lithium salt preferably include LiPF₆, LiBF₄, and LiClO₄. Examples of the nonaqueous solvent include propylene carbonate (PC), ethylene carbonate (EC), dimethyl carbonate (DMC), diethyl carbonate (DEC), and ethyl methyl carbonate (EMC). The lithium salt and the nonaqueous solvent can be used solely or in combination of two or more kinds. For example, the concentration of lithium salt is preferably in the range of 0.5 to 2.0 M (mole/L). It is preferable to add vinylene carbonate to the electrolytic solution from a viewpoint of durability.

### Separator

The separator is a porous film or a porous film laminate having a porous film integrated with a support. The separator may be made of only a porous film, or may be in the form of a porous film laminate integrated with a support. When the separator is a porous film laminate, the porous film may be formed at least on one side of the support, or may be formed on both sides of the support.

The separator has an air permeability value of, for example, 0.5 to 100 seconds, preferably 0.5 to 50 seconds, more preferably 0.5 to 20 seconds, and still more preferably 0.5 to 10 seconds. Since the air permeability is in the above range, a high air permeability can be maintained, so that the electric resistance of the secondary battery can be suppressed low.

The separator has a tensile strength of, for example, 2.0 N/15 mm or more, preferably 3.0 N/15 mm or more, more preferably 4.0 N/15 mm or more, and still more preferably 5.0 N/15 mm or more. When the tensile strength is 2.0 N/15 mm or more, the strength and flexibility of the separator can be maintained, and sufficient handleability is provided. The tensile strength of the separator can be measured, for example, using a universal tensile testing machine.

When the separator is a porous film laminate, it is preferable that interface separation between the support and the porous film does not occur in the following tape peel test. That is, it is preferable that the support and the porous film are laminated with an interlaminar adhesion strength high enough to prevent interface separation in the following tape peel test.

### Tape Peel Test

A tape peel test is performed by laminating a 24 mm-width masking tape [Film Masking Tape No. 603 (#25)] made by TERAOKA SEISAKUSHO CO., LTD. on the surface of the porous film of the porous film laminate, pressure-bonding the masking tape with the porous film laminate with a roller of 30 mm in diameter and 200 gf load, and then performing T-peel at a peel rate of 50 mm/minute by using a tensile testing machine.

When the separator, which is a porous film laminate as described before, is structured such that the porous film and the support are directly laminated with a specified interlaminar adhesion strength, the separator includes flexibility and excellent pore characteristics, while having an enhanced handleability since the separator has proper rigidity. To impart desired characteristics to the separator, heat treatment and film formation treatment may be applied to the separator as necessary.

The separator has an ion resistance value of, for example, 0.18Ω or less (for example, 0.01 to 0.18Ω), preferably 0.05 to 0.16Ω, more preferably 0.06 to 0.14Ω, and still more preferably 0.07 to 0.12Ω. When the separator has the ion resistance value in the above range, the electric resistance of the secondary battery can be suppressed low.

When the secondary battery of the present invention is a lithium-ion secondary battery, it is considered, for example, that the main electric resistance at the time of charging the secondary battery normally includes resistance (1) to (5), and resistance (6) that is a sum of direct-current resistance values of the positive electrode and the negative electrode:

(1) Lithium ions are released into the electrolytic solution from the positive electrode;
(2) The released lithium ions move in the electrolytic solution in a negative electrode direction;
(3) The lithium ions pass the separator;
(4) After passing the separator, the lithium ions move in the electrolytic solution in the negative electrode direction; and
(5) The lithium ions are stored in the negative electrode.

In the case of the lithium-ion secondary battery, the value of the ion resistance of the separator is a value determined by subtracting the resistance value (6) of the positive electrode and the negative electrode from the sum of the resistance values (2) to (4), i.e., a resistance value attributed to the separator and the electrolytic solution. In the electric resistance in the secondary battery, a polyolefin-based separator is conventionally and mainly used as a separator. The polyolefin-based separator does not have a margin for reducing the resistance, and therefore if the value of the ion resistance of the separator can be made lower than that of the polyolefin-based separator, the electric resistance of the entire secondary battery can also accordingly be made lower than that of the conventional secondary battery.

For example, in the case of the lithium-ion secondary battery, the value of the ion resistance of the separator can be determined by subtracting the resistance value (6) of the positive electrode and the negative electrode from the sum of the resistance values (2) to (4). The resistance values (2) to (4) and the sum (6) of the direct-current resistance values of the positive electrode and the negative electrode are generally called direct-current resistance, which can be obtained from, for example, an X intercept of a Nyquist plot obtained by measuring an alternating-current impedance of the secondary battery with an impedance analyzer. The direct-current resistance value (6) of the positive electrode and the negative electrode can be determined by measuring the direct-current resistance values of the positive electrode and the negative electrode respectively, and calculating the sum of the measured resistance values as a blank resistance value.

The electrolytic solution penetration rate of the separator is, for example, 10 to 30 mm/30 minutes, preferably 12 to 28 mm/30 minutes, and more preferably 15 to 25 mm/30 minutes in an MD direction (flow direction). When the ion electrolytic solution penetration rate of the separator is in the above range, the separator also has an excellent wettability for the electrolytic solution. The MD direction (flow direction) means an MD direction (flow direction) in the case of manufacturing the porous film as described later, and means that the direction of penetrating (developing) the electrolytic solution is the MD direction.

The electrolytic solution penetration rate of the separator is, for example, 12 to 30 mm/30 minutes, preferably 14 to 28 mm/30 minutes, and more preferably 16 to 25 mm/30 minutes in a TD direction (perpendicular direction). The TD direction (perpendicular direction) means the direction perpendicular to the MD direction (flow direction), and means that the direction of penetrating (developing) the electrolytic solution is the TD direction.

As described in Examples, the electrolytic solution penetration rate of the separator can be determined by introducing 4 g of an electrolytic solution (for example, EC/DEC is 1/1) into a glass vessel, placing a thin strip-like separator sample (for example, 1.5 cm×8.5 cm) on the surface of the electrolytic solution to be immersed therein, and measuring a penetration distance (development distance) of the liquid after 30 minutes.

The separator has a thickness of, for example, 10 to 60 μm, preferably 10 to 50 μm, more preferably 10 to 40 μm, and still more preferably 10 to 35 μm. When the thickness is less than 10 μm, it becomes difficult to stably manufacture the separator, whereas when the thickness exceeds 60 μm, air permeability may be deteriorated. When the separator is made of only a porous film, the thickness of the porous film is the same as the thickness of the separator.

### Porous Film

A main component of the porous film is a polyetherimide-based resin. In the present invention, the phrase that a main component is a polyetherimide-based resin means that the content of the polyetherimide-based resin is, for example, 50% by weight or more based on the total amount of the components constituting the porous film. The content of the polyetherimide-based resin is, for example, 50% by weight or more, preferably 70% by weight or more, and more preferably 90% by weight or more based on the total amount of the components constituting the porous film from a point of excellent heat resistance and stability for the electrolytic solution. It is particularly preferable that the porous film is made of only the polyetherimide-based resin.

As the polyetherimide-based resin, polyether imide or a copolymer (such as a graft polymer, a block copolymer, and a random copolymer) of polyether imide and other resins can be used, for example. Examples of other resins may include polysulfone, polyether sulfone, polyimide, polyamide, and polyamideimide. The polyetherimide-based resin can be used solely or in combination of two or more kinds. The polyetherimide-based resin is heat resistant, and excellent in chemical resistance and electric characteristics.

The polyetherimide-based resin has a glass transition temperature of, for example, 190 to 270° C., preferably 200 to 240° C., and more preferably 210 to 230° C. When the glass transition temperature is less than 190° C., and the temperature of separator rises due to a certain cause, not only clogging of the fine pores tends to occur, but also the separator may shrink to cause a short-circuit of the electrodes, and the separator may melt down and lose the function as a separator. In the case of a rapid temperature rise in particular, the aforementioned phenomena tend to occur. The glass transition temperature of polyether imide is 217° C.

It is also possible to use a resin having a glass transition temperature of less than 190° C. or more than 270° C. in the range that the effects of this application are not spoiled. The content of the resin having a glass transition temperature of less than 190° C. or more than 270° C. is, for example, 20% by weight or less, preferably 10% by weight or less, more preferably 5% by weight or less, and still more preferably 3% by weight or less based on the total amount of the components constituting the porous film.

The porous film preferably has a large number of micro-pores having communicating properties, the micro-pores having an average pore size of, for example, 0.01 to 10 μm, preferably 0.05 to 5 μm, more preferably 0.1 to 2 μm, still more preferably 0.1 to 1 μm, and particularly preferably 0.1 to 0.9 μm. When the average pore size is out of the above range, the porous film is poor in pore characteristics as it is difficult to obtain a desired effect according to use, and when the average pore size is less than 0.01 μm in particular, deterioration in air permeability, deterioration in penetration of the electrolytic solution, and increase in electric resistance or the like may occur, whereas when the average pore size exceeds 10 μm, a minute short-circuit of dendrite lithium metal and the like may occur.

The porous film has an average aperture ratio (void content) of, for example, 30 to 80%, preferably 40 to 80%, more preferably 50 to 80%, and still more preferably 60 to 80%. When the void content is out of the above range, it is hard to obtain desired pore characteristics corresponding to use, and when the void content is less than 30% in particular, the air permeability of the separator may deteriorate, transfer of lithium ions and the like may be disturbed, or the electrolytic solution may hardly penetrate through the separator, so that desired effects may not be obtained, whereas when the void content exceeds 80%, the strength and folding endurance of the separator may be poor.

The porous film has an aperture ratio (surface aperture ratio) on the surface of, for example, 48% or more (for example, 48 to 80%), and preferably 60 to 80%. When the surface aperture ratio is less than 48%, penetration performance may become insufficient, and also the electrolytic solution may hardly penetrate through the separator, whereas when the surface aperture ratio exceeds 80%, the strength and folding endurance of the separator tend to deteriorate.

The porous film has a surface roughness (arithmetic average surface roughness Sa) of, for example, 0.5 μm or less, preferably 0.4 μm or less, more preferably 0.3 μm or less, and still more preferably 0.2 μm or less. When the surface roughness exceeds 0.5 μm, smoothness is lost and, for example, lithium ions and the like unevenly diffuse on the surface, which may lead to localization of current density, and clogging of the pores and a short-circuit or the like may be caused by deposition of lithium metal and the like at the time of long-term use. The surface roughness (arithmetic average surface roughness Sa) may be determined by, for example, measuring the surface shape with a noncontact surface measuring system using optical interferometry.

Chemical resistance imparting treatment may be applied to the porous film. As a result, the chemical resistance is imparted to the porous film, which is advantageous in the point that defects, such as swelling, dissolution, and deterioration, can be avoided in the case where the porous film contacts solvents, acids, alkalis, and the like in a use form of the porous film. Examples of the chemical resistance imparting treatment may include: physical treatment with heat, ultraviolet rays, visible rays, electron rays, radioactive rays, and the like; and chemical treatment for coating the porous film with a chemical-resistant polymer and the like.

The porous film may be coated with a chemical-resistant polymer. Such a porous film may constitute a porous film having chemical resistance with a chemical-resistant coating formed on the surface of the porous film or the surface of internal micro-pores, for example. Here, examples of the chemicals may include publicly known chemicals which dissolve, swell, contract, and decompose the resin that constitutes the conventional porous film and thereby deteriorates the function as a porous film. Although it is difficult to categorically state the chemicals as they are different depending on the type of the resin constituting the porous film, specific examples of such chemicals may include: solvents having a high polarity such as ethylene carbonate (EC), diethyl carbonate (DEC), methylethyl carbonate (MEC), propylene carbonate (PC), dimethyl sulfoxide (DMSO), N,N-dimethylformamide (DMF), N,N-dimethylacetamide (DMAc), N-methyl-2-pyrrolidone (NMP), 2-pyrrolidone, cyclohexanone, acetone, methyl acetate, ethyl acetate, ethyl lactate, acetonitrile, methylene chloride, chloroform, tetrachloroethane, and tetrahydrofuran (THF); inorganic salts, such as sodium hydroxide, potassium hydroxide, calcium hydroxide, sodium carbonate, potassium carbonate; amines, such as triethylamine; alkali solutions, such as aqueous solutions and organic solvents in which alkalis such as ammonia are dissolved; inorganic acids, such as hydrogen chloride, sulfuric acid, and nitric acid; acidic solutions, such as aqueous solutions and organic solvents in which acid, such as organic acid having carboxylic acid such as acetic acid and phthalic acid, is dissolved; and mixtures of these.

The chemical-resistant high polymers may have excellent resistance to chemicals, such as solvents having a high polarity, alkalis, and acids, and examples of the chemical-resistant high polymer may include thermosetting resin or photo-setting resin, such as phenol-based resin, xylene-based resin, urea-based resin, melamine-based resin, benzoguanamine-based resin, benzoxazine-based resin, alkyd-based resin, triazine-based resin, furan-based resin, unsaturated polyester, epoxy-based resin, silicon-based resin, polyurethane-based resin, and polyimide-based resin; and resin such as polyvinyl alcohol, cellulose acetate-based resin, polypropylene reign, fluororesin, phthalic acid-based resin, maleic acid-based resin, saturated polyester, an ethylene-vinyl alcohol copolymer, chitin, and chitosan. These high polymers can be used solely or in combination of two or more kinds. The high polymers may be copolymers or graft polymerization substrates.

The porous film coated with such a chemical-resistant polymer is free from deterioration, such as dissolution, swell, or deformation of the porous film, when the porous film contacts chemicals such as solvents having a high polarity, alkalis, and acids, or can suppress the deterioration to the level that does not affect the use. For example, when the porous film is in contact with chemicals for a short time, the chemical resistance strong enough to prevent deterioration within the time frame may be imparted.

Since the chemical-resistant high polymers often have heat resistance together with the chemical resistance, it is less likely that the heat resistance of the porous film after coated with the chemical-resistant high polymer becomes lower than before.

The porous film has a thickness of, for example, 5 to 50 μm, preferably 7 to 40 μm, more preferably 10 to 30 μm, and still more preferably 10 to 20 μm. When the thickness is less than 5 μm, it becomes difficult to stably manufacture the porous film, whereas when the thickness exceeds 50 μm, air permeability may be deteriorated.

### Manufacturing Method of Porous Film

The porous film may be manufactured by, for example, a method (coagulation liquid contact method) of obtaining the porous film comprising: flow-casting a polymer solution containing a polyetherimide-based resin and the like constituting the porous film into the form of a film on a film base; applying a pore making treatment to the film by contacting the film with a coagulation liquid; then separating the film from the film base; and then drying the film. As the coagulation liquid contact method, publicly known methods, such as a wet phase transformation method (see, for example, Japanese Patent Laid-Open No. 2001-145826), a dry phase transformation method (see, for example, International Publication No. 98/25997 pamphlet), and a method using an agent for regulating the rate of solvent displacement (see, for example, Japanese Patent Laid-Open No. 2000-319442 and Japanese Patent Laid-Open No. 2001-67643) may be used.

As the polymer solution, for example a mixed solution consisting of a polymeric component containing a polyetherimide-based resin and the like that constitute the porous film, a water-soluble polymer, a water-soluble polar solvent, and as necessary water can be used.

The polymeric component is not particularly limited as long as the polyetherimide-based resin is contained, and therefore other resins, which are soluble in the water-soluble polar solvent and which can form a porous film by the phase transformation method, can also be used. Instead of the polymeric component, a monomer component (raw material) and an oligomer of the polyetherimide-based resin, and a precursor of the polyetherimide-based resin before imidization or cyclization may be used.

Adding the water-soluble polymer or water to the polymer solution is effective in order to make the film structure porous like sponge. Examples of the water-soluble polymer may include polyethylene glycol, polyvinyl pyrrolidone, polyethylene oxide, polyvinyl alcohol, polyacrylic acid, polysaccharide, and their derivatives and mixtures of these. Among these polymers, polyvinyl pyrrolidone is preferable in the point of being able to suppress formation of a void inside the porous film and to enhance the mechanical strength of the porous film. These water-soluble polymers can be used solely or in combination of two or more kinds. From a viewpoint of porosity, the water-soluble polymer may preferably have a molecular weight of 200 or more, more preferably 300 or more, still more preferably 400 or more (for example, about 400 to 200,000), and particularly preferably 1,000 or more. Addition of water can adjust a void diameter in such a way that, for example, the void diameter can be decreased by reducing the amount of water to be added to the polymer solution.

The water-soluble polymer is extremely effective to make a sponge-like film structure, and various structures can be obtained by changing the type and amount of the water-soluble polymer. Accordingly, for imparting desired pore characteristics, the water-soluble polymer is extremely preferable as an additive used in forming the porous film. The water-soluble polymer is also an unnecessary component that does not constitute the porous film and needs to be removed in the end. In the method of using the wet phase transformation method, the water-soluble polymer is easily washed and removed in the step of phase transformation where the water-soluble polymer is soaked in a coagulation liquid, such as water. In contrast, in the dry phase transformation method, the component (unnecessary component) that does not constitute the porous film is removed by heating, so that removing the water-soluble polymer by heating is not as easy as in the case of using the wet phase transformation method. Thus, the manufacturing method using the wet phase transformation method is more advantageous than the case of using the dry phase transformation method in the point that the porous film having desired pore characteristics can be manufactured easily.

Examples of the water-soluble polar solvent may include dimethyl sulfoxide, N,N-dimethylformamide, N,N-dimethylacetamide (DMAc), N-methyl-2-pyrrolidone (NMP), 2-pyrrolidone, and mixtures of these, and therefore those (good solvents for the polymeric component) having solubility in accordance with the chemical frame of a resin to be used as the polymeric component can be used.

As the polymer solution, a mixed solution consisting of 8 to 25% by weight of the polyetherimide-based resin component (the polymeric component and precursor component thereof) that constitutes the porous film, 5 to 50% by weight of a water-soluble polymer, 0 to 10% by weight of water, and 30 to 82% by weight of a water-soluble polar solvent is preferable. In this case, when the concentration of the polymeric component is too low, the thickness of the porous film becomes insufficient, and desired pore characteristics become hard to be obtained. When the concentration of the polymeric component is too high, the void content tends to be smaller. While the water-soluble polymer is added to form a homogenous sponge-like porous structure inside the porous film, a huge void over 10 μm would be generated inside the porous film and homogeneity is deteriorated if the concentration is too low. When the concentration of the water-soluble polymer is too high, the solubility is deteriorated, and when the concentration exceeds 50% by weight, defects such as porous film strength being weakened tend to occur. The void diameter can be adjusted by using the amount of the water-soluble polymer to be added, and it becomes possible to increase the void diameter by increasing the amount to be added.

The content of the water-soluble polymer in the polymer solution is, for example, 5 to 40 parts by weight, preferably 8 to 35 parts by weight, and more preferably 10 to 30 parts by weight per 100 parts by weight in total of the polyetherimide-based resin component (a polymeric component and a precursor component thereof) that constitutes the porous film and the water-soluble polar solvent. By adjusting the content of the water-soluble polymer, the size of pores (average pore size) of the porous film can be adjusted.

When the polymer solution is flow-casted into the form of a film, it is desirable to retain the film for 0.2 to 15 minutes under the atmosphere having a relative humidity of 70 to 100% and temperature of 15 to 90° C., and then to guide the film to a coagulation liquid made of a nonsolvent polymeric component. Retaining the flow-casted film-like substance under the above conditions, the porous film can be made homogenous and high in communicating properties. This is considered to be because, when the film is put under humidification, moisture infiltrates into the film from the film surface, and efficiently promotes phase separation of the polymer solution. In particularly preferable conditions, relative humidity is 90 to 100% with temperature being 30 to 80° C., and relative humidity is about 100% (for example, 95 to 100%) with temperature being 40 to 70° C. When the content of moisture in the air is less than this, the surface aperture ratio may become insufficient.

According to the manufacturing method of the porous film, the porous film having a large number of micro-pores having communicating properties, the micro-pores having an average pore size of 0.01 to 10 μm, can easily be manufactured. As described before, the size (average pore size) of the micro-pores, the void content, and the surface aperture ratio of the porous film in the present invention can be adjusted to desired values by properly selecting, for example, the types and amounts of the components constituting a polymer solution, the amount of water to be used, and the humidity, temperature, and time in flow-casting.

The coagulation liquid used in the coagulation liquid contact method may be a solvent that coagulates the polyetherimide-based resin, and for example, water-soluble coagulation liquids including: water; alcohols including monohydric alcohols such as methanol and ethanol, and polyhydric alcohols such as glycerol; a water-soluble polymer such as polyethylene glycol; and a mixture of these, can be used.

In the manufacturing method of the porous film, the porous film can be manufactured by guiding a polymer solution to the coagulation liquid to mold a porous film on the film base surface, then separating the porous film, and drying the porous film without other steps. Since the drying is not particularly limited as long as a solvent component, such as a coagulation liquid, can be removed, the drying may be under heating, or may be air drying at room temperature. The method of heating treatment is not particularly limited, so that a hot air treatment, a hot calender treatment, or a method of introducing the film to a constant temperature bath, an oven, and the like may be used, as long as the temperature of the porous film can be controlled to a specified temperature. Heating temperature can be selected from a wide range of room temperature to about 200° C., for example. An atmosphere in the heating treatment may by any one of air, nitrogen, and inactive gas. Although use of air is the most inexpensive, it may involve oxidation reaction. To avoid the oxidation reaction, nitrogen and inactive gas may be used, and nitrogen is preferred in terms of cost. Heating conditions are properly set in consideration of productivity, physical properties of the porous film, and the like.

The thus-obtained porous film may be further subjected to crosslinking treatment with use of heat, visible rays, ultraviolet rays, electron rays, radioactive rays, and the like. The crosslinking treatment promotes polymerization, crosslinking, hardening, and the like of the precursor constituting the porous film so that a high polymer is formed, which makes it possible to obtain a porous film with further enhanced characteristics, such as rigidity and chemical resistance. For example, when the porous film molded with the polyimide-based precursor is further subjected to heat imidization, chemical imidization, or the like, a polyimide porous film can be obtained. Heat crosslinking may be applied at the same time when the heating treatment for drying the film is performed after the film is guided to the coagulation liquid.

### Porous Film Laminate

The porous film laminate has high mechanical strength in particular, when the laminate is structured such that the porous film and the support are integrated with excellent adhesion. Accordingly, the porous film laminate is advantageous in the point that sufficient strength can be demonstrated even when the thickness of the porous film laminate is as thin as less than about 50 μm, for example.

### Support

As the support, a nonwoven fabric substrate, a porous film, a mesh fabric, a filter paper, and the like can be used, for example. Among these, the nonwoven fabric substrate is particularly preferable as the support in terms of workability, mechanical strength, cost, and a thinner thickness. The support may be a monolayer or may be a laminate of a plurality of layers made of the same or different materials. The plurality of layers may be a laminated film which is formed by laminating a plurality of supports with adhesives or the like as necessary or which is laminated in the manufacturing stage, or may be obtained by application of treatment such as coating, deposition, and sputtering.

The support may be subjected to surface treatment, such as roughening treatment, easily-adhesive treatment, static electricity prevention treatment, sandblast treatment (sand mat treatment), corona discharge treatment, plasma treatment, chemical etching treatment, water mat treatment, flame treatment, acid treatment, alkali treatment, oxidation treatment, UV irradiation treatment, and silane coupling agent treatment.

It is also possible to perform two or more surface treatments in combination. For example, a method may be used in which the support is first subjected to any one of the treatments including the corona discharge treatment, the plasma treatment, the flame treatment, the acid treatment, the alkali treatment, the oxidation treatment, and the UV irradiation treatment, and then is subjected to the silane coupling agent treatment. Depending on the type of the support, the described method may enhance the treatment as compared with the case where the silane coupling agent treatment is performed independently. Examples of the silane coupling agent may include products made by Shin-Etsu Chemical Co., Ltd. or Japan Energy Corporation.

The support (nonwoven fabric substrate in particular) has a thickness of, for example, 5 to 40 μm, preferably 5 to 30 μm, more preferably 5 to 20 μm, and still more preferably 5 to 10 μm. When the thickness becomes too small, it becomes difficult to handle the support, whereas when the thickness is too large, the ionic permeability of the battery may deteriorate.

When the support is a nonwoven fabric substrate, the fabric weight is, for example, 2 to 20 g/m², preferably 2 to 15 g/m², more preferably 2 to 10 g/m², and still more preferably 2 to 8 g/m² from a viewpoint of retaining strength and flexibility.

The support (nonwoven fabric substrate in particular) has a density of, for example, 0.05 to 0.90 g/cm³, preferably 0.10 to 0.80 g/cm³, and still more preferably 0.15 to 0.70 g/cm³ from a viewpoint of securing proper air permeability.

The support (nonwoven fabric substrate in particular) has an air permeability of, for example, 30 seconds or less, preferably 20 seconds or less, and more preferably 10 seconds or less. Although the limit of measurement of the air permeability is about 0.1 second, a support having an air permeability of less than 0.1 second is also included in the support.

From a viewpoint of enhancing the adhesion between the support and the porous film, it is preferable to apply, to the side of the surface of the support on which the porous film is laminated, proper surface treatment, such as sandblast treatment (sand mat treatment), corona discharge treatment, acid treatment, alkali treatment, oxidation treatment, UV irradiation treatment, plasma treatment, chemical etching treatment, water mat treatment, flame treatment, and silane coupling agent treatment. As the silane coupling agent, the agent described before may be used. Two or more surface treatments may be applied in combination, and depending on the nonwoven fabric substrate, it is preferable to apply the silane coupling agent treatment in combination with other treatments.

The nonwoven fabric refers to a sheet-like fabric obtained by arraying fibers, and bonding the fibers to each other with adhesives or by fusing force or force of entanglement of fibers themselves, and paper is also included in the concept of the nonwoven fabric. The nonwoven fabric can be manufactured by generally known methods such as, a papermaking method, a melt blowing method, a spunbonding method, a needlepunching method, and an electrospinning method. The type of the resin that constitutes the fibers can be selected corresponding to a melting point, chemical resistance, and the like.

For the nonwoven fabric, it is preferable that the melting point of the resin that constitutes the fibers is lower than the glass transition temperature of polyetherimide-based resin, and as such a resin, polyolefin, polyester, polyamide, and the like may be used, for example. The nonwoven fabric may be a bilayer nonwoven fabric or a multilayered nonwoven fabric, which is made of these fibers, and among these, the bilayer nonwoven fabric including a polyolefin nonwoven fabric is preferable.

As the nonwoven fabric, a commercially available product may be used. For example, polyolefin nonwoven fabrics by Hirose Paper Mfg Co., Ltd. (trade name “06HOP-2”, “06HOP-4”, “HOP-10H”), and the like are available. In addition, a bilayer nonwoven fabric by Hirose Paper Mfg Co., Ltd. (trade name “05EP-16”) and the like are available.

Since the above-mentioned nonwoven fabric is used as the nonwoven fabric substrate, there is an advantage that the porous film can be laminated with excellent interlaminar adhesion strength by laminating the film on the surface of the substrate by a heat sealing method and the like. Since the porous film made of the nonwoven fabric has flexibility and excellent pore characteristics while having proper rigidity, the effect of enhancing the handleability can be obtained.

When the support (nonwoven fabric substrate in particular) contains the resin or fiber that constitutes the nonwoven fabric, the content thereof is, for example, 60% by weight or more, preferably 80% by weight or more, and more preferably 90% by weight or more relative to the entire support.

The porous film laminate has a thickness of, for example, 10 to 60 μm, preferably 15 to 50 μm, more preferably 20 to 40 μm, and still more preferably 25 to 35 μm. When the thickness is less than 10 μm, it becomes difficult to stably manufacture the porous film laminate, whereas when the thickness exceeds 60 μm, air permeability may be deteriorated.

### Lamination Method of Support and Porous Film

### (Manufacturing Method of Porous Film Laminate)

A support and a porous film can be laminated by heat sealing or other methods, and to be more specific, a laminate (porous film laminate) having a nonwoven fabric substrate in close contact with the porous film can be obtained by putting the porous film on at least one surface of the support, and heating the support and the porous film from the side of the porous film or from both the sides with a heat source so as to slightly melting the surface of the support that is in contact with the porous film. In this case, in order to protect the porous film, the support, or both the porous film and the support from friction and the like, a protective film may preferably be put on one side or both the sides of the laminate. As the heat source, an iron, a laminating machine, a heating roller, and the like can be utilized, and a laminating apparatus, a heat seal apparatus, a calender apparatus, a roll press apparatus, and the like can be also used.

The heating temperature for heat-sealing the support and the porous film is preferably lower than the glass transition temperature of polyetherimide-based resin, and equal to or more than the melting point of the resin that constitutes the support. For example, when a nonwoven fabric substrate made of polyolefin, such as polyethylene and polypropylene, is used as the support, the heating temperature may be about 140 to 170° C. since the melting point of polyolefin is about 130 to 165° C. The heating temperature is a temperature of a portion where the porous film and the support are in contact.

When the support is a nonwoven fabric substrate in particular, the air permeability measured with a Gurley densometer is generally 0.1 second, which is a limit of measurement, or less, and therefore even when part of the polyolefin-based nonwoven fabric is thermally deformed by heat sealing, the air permeability is hardly affected. However, it is not preferable to retain the support for a long time at the temperature above the melting point of the resin that constitutes the nonwoven fabric. Technical points for controlling the heat sealing include heating temperature, moving velocity of a heat source, and pressure, and it is important to appropriately control these parameters. With such a method, it is possible to easily obtain a laminate in which the porous film having excellent pore characteristics and the support are directly laminated. The obtained laminate is structured such that one surface or both the surfaces of the support are coated with the porous film, the porous film having a large number of micro-pores having communicating properties, the micro-pores having an average pore size of, for example, 0.01 to 10 μm.

Coating Separator (Porous Film) with Heat-Resistant Protective Layer

As described in Background Art, the polyolefin-based separator having a heat-resistant protective layer (HRL) provided on one surface or both the surfaces of the separator are disclosed (Patent Literatures 2 and 3). By the same method as in Patent Literatures 2 and 3, a separator (porous film) can be coated with the heat-resistant protective layer (HRL). With such coating, further improvement in heat resistance can be achieved, and a function of suppressing damage on the separator caused by oxidation-reduction reaction in the battery can also be expected.

As a method for coating the separator (porous film), a manufacturing method and the like can be utilized, the manufacturing method being characterized by coating one surface or both the surfaces of a porous film with a solution (dope) made of a thermally stable polymer and a water soluble organic solvent with use of a coating apparatus, performing an air gap step, then conveying the coated porous film to a coagulation bath containing a coagulation liquid consisting of water or a mixed liquid of water and the organic solvent, then further coagulating the porous film by dipping the porous film in the coagulation bath such that one surface or both the surfaces of the coated porous film are in direct contact with the coagulation liquid, and thereafter, washing and drying the porous film. Specifically, the manufacturing method publicly known in Japanese Patent Laid-Open No. 2003-171495 may suitably be applied.

The heat-resistant protective layer (HRL) may contain not only the thermally stable polymer but also a large amount of inorganic particles. As the inorganic particles in the heat-resistant porous layer, oxides such as alumina, titania, silica, and zirconia, carbonate, phosphate, hydroxides, and the like may suitably be used, for example. Such inorganic particles are preferably high in crystallinity from a viewpoint of elution of impurities and durability.

### EXAMPLES

Hereinafter, the present invention will be described in more detail with examples, though the present invention is not limited by the following examples. Average pore size, average aperture ratio (void content), air permeability, blank resistance, separator ion resistance, and electrolytic solution penetration rate were measured by the following methods. Electrolytic solution development properties and heat resistance were estimated by the following methods.

### Average Pore Size

Based on an electron microscope photograph, the area of any 30 or more pores on the surface or a cross section of a porous film was measured, and an average value of the measured areas was obtained as an average pore area Sₐᵥₑ. On the assumption that the pores were perfect circles, an average pore size was obtained by converting the average pore area into a pore size by the following expression. In the expression, n represents a circular constant.

Average pore size [μm]=2·(Sₐᵥₑ/π)^{1/2}

### Average Aperture Ratio (Void Content)

The average aperture ratio (void content) of the porous film was calculated by the following expression.

V represents a volume [cm³] of the porous film, W represents a weight [g] of the porous film, and ρ represents a density [g/cm³] of a porous film material (resin). The density of polyether imide was set to 1.27 [g/cm³].

Average aperture ratio (void content) [%]=100−100·W/(ρ·V)

### Air Permeability

Air permeability was measured according to JIS P8117 with a Gurley densometer type B by Tester Sangyo Co., Ltd. The number of seconds was measured by a digital auto counter. As the value of air permeability (Gurley value) is smaller, it is indicated that the permeability of air is higher, i.e., the communicating properties of micro-pores in the porous film are higher. In this specification, both the air permeability of the laminate and the air permeability of the substrate were estimated by this examination method unless otherwise stated.

### Blank Resistance

As the positive electrode, an electrode formed by laminating a ternary system active material (NCM):AB:PVdF=93:4:3 on an aluminum foil current collector into a thickness of 80 μm was used, and an electrode formed by laminating graphite:CMC:SBR=97.5:1:1.5 on a copper foil current collector into a thickness of 70 μm was used as the negative electrode. Both the positive electrode and the negative electrode had a size of 50 mm×20 mm (10 cm²). After the positive electrode was dried at 170° C. for 10 hours, and the negative electrode was dried at 120° C. for 10 hours, direct-current resistance values of the positive electrode and the negative electrode were measured in the state where pressure of 2 kgf/cm² was applied to each of the electrodes, and a sum of the direct-current resistance values of the positive electrode and the negative electrode were defined as a blank resistance. The blank resistance was 0.03Ω.

### Ion Resistance of Separator

Using an impedance analyzer by TOYO Corp. (model: PARSTAT MC PMC1000), an alternating-current impedance of a prepared lithium-ion secondary battery cell was measured under the condition that scanning frequency was 0.1 Hz to 50000 Hz, and voltage amplitude was 10 mV. With an X intercept of an obtained Nyquist plot as a direct-current resistance component of the lithium-ion secondary battery cell, the above obtained blank resistance was subtracted from the direct-current resistance component, and a resultant value was defined as the ion resistance of the separator.

### Electrolytic Solution Penetration Rate

As an electrolytic solution, 4 g of EC/DEC(1/1) was put into a 20 cc-glass vessel, and a thin strip-like separator sample (1.5 cm×8.5 cm) was placed on the liquid surface to be immersed therein. A penetration distance (development distance) of the liquid after 30 minutes was measured. When the penetration distances measured at both the edges of the sample were different, an average value was used as the penetration distance. The electrolytic solution penetration rate was expressed as a penetration distance after 30 minutes (mm/30 minutes). Since a conventional polyolefin separator was punctured by stretching, the pore structure thereof had anisotropy, and therefore the distance was measured in both the MD direction (flow direction) and the TD direction (perpendicular direction).

### Electrolytic Solution Development Properties

The separator sample was cut into 6 cm×6 cm such that the MD direction (flow direction) and the TD direction (perpendicular direction) can be identified. One drop of EC/DEC (weight ratio; 1/1) was dropped as an electrolytic solution onto the center of the sample with a syringe. The development status of the electrolytic solution was observed immediately after dropping, 5 minutes after dropping, and 10 minutes after dropping.

### Heat Resistance

Separator samples (6 cm×10 cm) were laid on PTFE (fluororesin) plates without being fixing, heated in temperature tanks to target temperatures (100° C., 120° C., 140° C., 160° C., 180° C., 200° C., 220° C., 240° C., 260° C., 270° C.), and maintained for 5 minutes at the respective target temperatures to observe the status, such as curls and contraction of the samples.

### Manufacturing Example 1

A stock solution for film production was prepared by adding 28 parts by weight of polyvinyl pyrrolidone (molecular weight 55,000) as water-soluble polymer to 100 parts by weight of a polyetherimide-based resin solution (glass transition temperature 217° C.; trade name “Ultem 1000P” made by SABIC Innovative Plastics; 16% by weight solids concentration, solvent NMP).

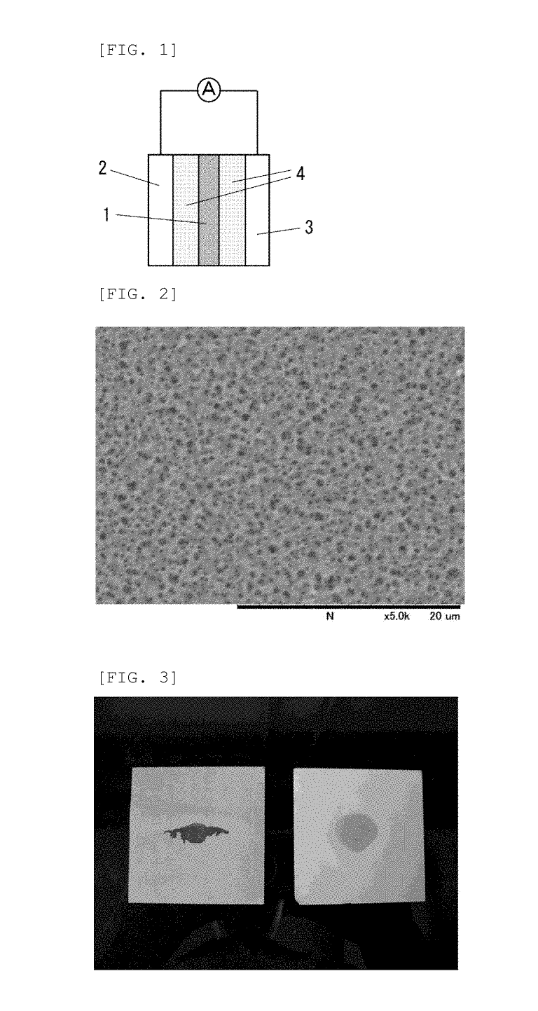

A PET film made by Teijin DuPont (thickness 100 μm: trade name “HS74AS”) as a substrate was placed on a glass plate with an easily-adhesive surface of the PET film facing upward, and the stock solution retained at 25° C. was casted on the PET film using a film applicator. At the time of casting, a gap between the film applicator and the PET film was 102 μm. Immediately after being casted, the stock solution was retained in a container with humidity of about 100% and temperature of 50° C. for 3 minutes. Then, while the casted stock solution was immersed in water for coagulation and washing, a porous film naturally separated from the PET film. The porous film (separator) was obtained by air-drying under room temperature. The thickness of the porous film was 32 μm. When the porous film was observed with an electron microscope, the pores present on the surface of the porous film had an average pore size of 0.3 μm, the inside of the porous film was substantially homogenous, so that the micro-pores having an average pore size of 0.3 μm and having communicating properties were present over the entire region. The void content inside the porous film was 75%. The air permeability of the porous film was measured to be 8 seconds. FIG. 1 illustrates an electron microscope photograph (SEM photograph) of the surface of the porous film obtained in Manufacturing Example 1.

### Example 1

A lithium-ion secondary battery (monolayer laminate cell) was fabricated by the following method.

The positive electrode described in “Blank Resistance” was punched into 30×50 mm, and the negative electrode described in “Blank Resistance” was punched into 32×52 mm, the positive electrode was dried at 170° C. for 10 hours, the negative electrode was dried at 120° C. for 10 hours, then the positive electrode and the negative electrode were made to face each other through the separator (porous film) made of the polyetherimide-based resin in Manufacturing Example 1, and were inserted into an aluminum laminate outer packaging, an electrolytic solution (1M-LiPF₆/3EC7MEC) was injected into the outer packaging, and after impregnation under reduced pressure, the outer packaging was vacuum-sealed to fabricate a cell.

In accordance with the ion resistance of the separator, an ion resistance value of the separator in the lithium ion battery (monolayer laminate cell) fabricated by the described method was obtained. The ion resistance of the separator in Example 1 was 0.10Ω.

### Comparative Example 1

As a Comparative Example, a polyethylene micro-porous film separator (thickness of 20 μm, average pore size of 0.05 μm, voidage of 40%) was used. A lithium ion battery (monolayer laminate cell) was fabricated by a method the same as that of Example 1 except that the polyethylene micro-porous film separator was used.

In accordance with the measurement of the ion resistance of the separator, an ion resistance value of the separator in the lithium ion battery (monolayer laminate cell) fabricated by the described method was obtained. The ion resistance of the separator in Comparative Example 1 was 0.21Ω.

### Comparative Example 2

As a Comparative Example, the electrolytic solution penetration rate was measured using a polyolefin micro-porous film separator (thickness of 25 μm, average pore size of 0.064 μm, voidage of 55 μm, and air permeability of 200 seconds).

A thin strip long in the MD direction (flow direction) and a thin strip long in the TD direction (perpendicular direction) were fabricated, and the electrolytic solution penetration rates of the respective strips were measured to be 3 mm/30 minutes in the MD direction and 8 mm/30 minutes in the TD direction. The penetration rate had anisotropy as the penetration rate was higher in the TD direction. Since the penetration rate is low, it is difficult for the electrolytic solution to go into the separator, and furthermore, the penetration rate has nearly three-times anisotropy, there is a possibility that a portion in which it is difficult for the electrolytic solution to go thereinto occurs.

Next, the electrolytic solution development properties and heat-resistant of the polyolefin micro-porous film separator were evaluated.

In evaluation of the electrolytic solution development properties, wetting spread more in the TD direction than in the MD direction. Furthermore, as a result of observing the development status of the electrolytic solution penetration after 5 minutes and after 10 minutes, the wet area slightly enlarged after 5 minutes (left side of FIG. 3), but the status after 10 minutes was almost unchanged from the status after 5 minutes. A central droplet was observed to be in a raised state even after 10 minutes. Since it is difficult for the electrolytic solution to go into the separator, and the electrolytic solution has anisotropy in wet-spreading, there is a possibility that a portion in which it is difficult for the electrolytic solution to go thereinto occurs.

In the heat-resistant evaluation, curls were generated at 100° C., 120° C., 140° C., and 160° C., and disappearance of pores occurred due to contraction at 180° C., and the separator was liquefied at 220° C. or above.

### Example 2

When the electrolytic solution penetration rate was measured using the separator made of polyetherimide-based resin in Manufacturing Example 1, the electrolytic solution penetration rates in the MD direction and the TD direction were 17 mm/30 minutes and 20 mm/30 minutes, respectively. The penetration rates in the MD direction and the TD direction were almost identical, and there was no anisotropy in the penetration rate. The penetration rate is six times larger in the MD direction and 2.5 times larger in the TD direction than the penetration rate of the polyolefin micro-porous film separator of Comparative Example 1, and therefore it can be deemed that the electrolytic solution easily goes into the separator. Since there is almost no anisotropy in the penetration rate, it can be deemed that the electrolytic solution homogenously spreads and it is less likely that a portion in which it is difficult for the electrolytic solution to go thereinto occurs.

Next, the electrolytic solution development properties and heat-resistance were evaluated using the separator made of polyetherimide-based resin in Manufacturing Example 1.

In evaluation of the electrolytic solution development properties, wetting spread almost homogenously in the MD direction and the TD direction. Furthermore, as a result of observing the development status of the electrolytic solution after 5 minutes and after 10 minutes, the wet area slightly enlarged after 5 minutes (right side of FIG. 3), but the status after 10 minutes was almost unchanged from the status after 5 minutes. A central droplet went into the separator and wetting spread after 5 minutes, and a raised portion was not observed. Since the electrolytic solution easily goes into the separator, and the electrolytic solution has no anisotropy in wet-spreading, it can be deemed that it is less likely that a portion in which it is difficult for the electrolytic solution to go thereinto occurs.

In heat-resistant evaluation, almost no change was observed up to 200° C., and contraction was observed at 220° C. or above, though the film shape was maintained even at 270° C.

### INDUSTRIAL APPLICABILITY

Since the secondary battery of the present invention has a separator better in heat resistance than the conventional separator for a secondary battery and lower in electric resistance than the conventional separator for a secondary battery, the secondary battery of the present invention is useful as a secondary battery having both the safety and the high output. Moreover, since the secondary battery of the present invention has a separator excellent in wettability for the electrolytic solution, the secondary battery of the present invention is useful as a secondary battery having both the safety and the productivity.

### REFERENCE SIGNS LIST

1 Separator
2 Negative electrode
3 Positive Electrode
4 Electrolytic solution

1. A secondary battery comprising:
a negative electrode;
a positive electrode;
a separator disposed between the electrodes; and
an electrolytic solution, wherein
the separator is a porous film, or a porous film laminate having a porous film integrated with a support,
a main component of the porous film is a polyetherimide-based resin, and
in the following configuration of the secondary battery, an ion resistance value of the separator as determined by the following measuring method is 0.18Ω or less;
Configuration of the secondary battery: the positive electrode and the negative electrode defined below are made to face each other through the separator, and inserted into an aluminum laminate outer packaging, an electrolytic solution (1M-LiPF₆/3EC7MEC) is injected into the outer packaging, and after impregnation under reduced pressure, the outer packaging is vacuum-sealed;
Positive electrode: a laminate formed by laminating a mixture of a ternary system positive-electrode active material (NCM):AB:PVdf=93:4:3 on an aluminum foil current collector, the laminate being 30 mm in width, 50 mm in length, and 80 μm in thickness;
Negative electrode: a laminate formed by laminating a mixture of graphite:CMC:SBR=97.5:1:1.5 on a copper foil current collector, the laminate being 32 mm in width, 52 mm in length, and 70 μm in thickness; and
Measuring method: measuring an alternating-current impedance of the secondary battery with an impedance analyzer under conditions of a scanning frequency of 0.1 Hz to 50000 Hz and a voltage amplitude of 10 mV, obtaining an X intercept of an obtained Nyquist plot as a direct-current resistance component of the secondary battery, and subtracting blank resistance from the X intercept to obtain an ion resistance value of the separator.

2. A secondary battery comprising:
a negative electrode;
a positive electrode;
a separator disposed between the electrodes; and
an electrolytic solution, wherein
the separator is a porous film, or a porous film laminate having a porous film integrated with a support,
a main component of the porous film is a polyetherimide-based resin, and
the separator has an electrolytic solution penetration rate value of 10 to 30 mm/30 minutes in an MD direction.

3. The secondary battery according to claim 2, wherein the separator has an electrolytic solution penetration rate value of 12 to 30 mm/30 minutes in a TD direction.

4. The secondary battery according to claim 1, wherein
the porous film of the separator has a large number of micro-pores having communicating properties, the micro-pores having an average pore size of 0.01 to 10 μm,
the porous film has an average aperture ratio of 30 to 80%,
the separator has an air permeability value of 0.5 to 100 seconds, and
the separator has a thickness of 10 to 60 μm.

5. The secondary battery according to claim 1, wherein the micro-pores of the porous film have an average pore size of 0.05 to 5 μm.

6. The secondary battery according to claim 1, wherein the porous film has an average aperture ratio of 40 to 80%.

7. The secondary battery according to claim 1, wherein the separator has an air permeability value of 0.5 to 50 seconds.

8. The secondary battery according to claim 1, wherein the separator has a thickness of 15 to 50 μm.

9. The secondary battery according to claim 1, wherein the current collector of the negative electrode is a copper foil or stainless steel.

10. The secondary battery according to claim 1, wherein the current collector of the positive electrode is aluminum foil or stainless steel.

11. The secondary battery according to claim 1, wherein a raw material of the porous film is a polymer solution comprising 8 to 25% by weight of a polyetherimide-based resin component, 5 to 50% by weight of a water-soluble polymer, 0 to 10% by weight of water, and 30 to 82% by weight of a water-soluble polar solvent.

12. The secondary battery according to claim 11, wherein a content of the water-soluble polymer is 5 to 40 parts by weight per 100 parts by weight in total of the polyetherimide-based resin component and the water-soluble polar solvent.

13. The secondary battery according to claim 2, wherein
the porous film of the separator has a large number of micro-pores having communicating properties, the micro-pores having an average pore size of 0.01 to 10 μm,
the porous film has an average aperture ratio of 30 to 80%,
the separator has an air permeability value of 0.5 to 100 seconds, and
the separator has a thickness of 10 to 60 μm.

14. The secondary battery according to claim 3, wherein
the porous film of the separator has a large number of micro-pores having communicating properties, the micro-pores having an average pore size of 0.01 to 10 μm,
the porous film has an average aperture ratio of 30 to 80%,
the separator has an air permeability value of 0.5 to 100 seconds, and
the separator has a thickness of 10 to 60 μm.

15. The secondary battery according to claim 2, wherein the micro-pores of the porous film have an average pore size of 0.05 to 5 μm.

16. The secondary battery according to claim 3, wherein the micro-pores of the porous film have an average pore size of 0.05 to 5 μm.

17. The secondary battery according to claim 4, wherein the micro-pores of the porous film have an average pore size of 0.05 to 5 μm.

18. The secondary battery according to claim 2, wherein the porous film has an average aperture ratio of 40 to 80%.

19. The secondary battery according to claim 3, wherein the porous film has an average aperture ratio of 40 to 80%.

20. The secondary battery according to claim 4, wherein the porous film has an average aperture ratio of 40 to 80%.
